(19) United States
(12) Patent Application Publication
(10) Pub. No.: US 2009/0176198 A1
(43) Pub. Date: Jul. 9, 2009

(54) REAL NUMBER RESPONSE SCORING METHOD

(76) Inventors: James H. Fife, Langhorne, PA (US); Jeffrey M. Bolden, Princeton, NJ (US)

Correspondence Address: MAYER BROWN LLP, P.O. BOX 2828, CHICAGO, IL, 60690, US

(21) Appl. No.: 12/348,753

(22) Filed: Jan. 5, 2009

Related U.S. Application Data
(60) Provisional application No. 61/019,137, filed on Jan. 4, 2008.
(60) Provisional application No. 61/024,799, filed on Jan. 30, 2008.
(60) Provisional application No. 61/025,507, filed on Feb. 1, 2008.

(51) Int. Cl. G09B 19/00

(52) U.S. Cl. 434/353; 434/156

(57) ABSTRACT

The invention generally concerns a method of generating a real number score for a response, such as a written essay response. The method comprises providing a scoring model having one or more concepts; determining for each concept a probability that the concept is present in the response; creating a scoring rule or scoring rule function; determining an expected value function for the scoring rule; and generating a real number score for the response based on the scoring rule, the expected value function, and the probabilities that the concepts are present in the response (or a combination thereof). The real number score for the response may then be displayed or output, for instance, where the method is implemented as a computer system or application. Concept-based scoring provides improved scoring accuracy and individualized feedback for students and reports for teachers and parents.

### RELATED APPLICATIONS

This application claims priority to three provisional applications, each of which is incorporated herein by reference in its entirety: U.S. Ser. No. 61/019137 “Real Number Response Scoring Method” filed Jan. 4, 2008, U.S. Ser. No. 61/024799 “C-Rater: Automatic Content Scoring For Short Constructed Responses” filed Jan. 30, 2008, and U.S. Ser. No. 61/025507 “Assessment And Learning: Automated Content Scoring Of Free-Text” filed Feb. 1, 2008.

### FIELD OF THE INVENTION

The invention relates generally to methods for written response evaluation. More specifically, the invention relates to methods for determining real number concept-based scores and individualized feedback for written responses.

### BACKGROUND OF THE INVENTION

Gaining practical writing experience is generally regarded as an effective method of developing writing skills. Literature pertaining to the teaching of writing suggests that practice and critical evaluation may facilitate improvements in students' writing abilities. In traditional writing classes an instructor may provide this essay evaluation to the student. However, attending writing classes may be inconvenient or prohibitively expensive. In addition, individual scoring of responses may be inefficient where multiple essays are to be evaluated, such as in situations involving standardized tests or entrance exams. Automated essay scoring applications can improve efficiency and reduce costs through all levels of school and other relatively large-scale assessment conditions.

In comparison to human evaluators, however, conventional automated essay scoring applications may not perform well. This performance disparity may be related to the manner in which conventional automated essay scoring methods determine the presence of necessary essay elements or concepts. In order to simplify calculations, such methods will review essays and make a deterministic output, concluding that each element is either present or absent. Such methods will then use these binary determinations to calculate a final integer or discrete-stepped score for the essay response. However, such scoring methods essentially ignore the probabilities associated with the possible presence of elements in the response, and therefore discount the supplemental information that these probabilities may provide in determining an accurate final score.

### SUMMARY OF THE INVENTION

In one embodiment, the invention concerns a method of generating a real number score for a response, such as a written essay response. The method generally comprises providing a scoring model having one or more concepts, determining for each concept a probability that the concept is present in the response, creating a scoring rule or scoring rule function, determining an expected value function for the scoring rule, and generating a real number score for the response based on the scoring rule, the expected value function, and the probabilities that the concepts are present in the response (or a combination thereof). The real number score for the response may then be displayed or output where, for instance, the method is implemented as a computer system.

The scoring model may be created to correspond with a scoring rubric, wherein the scoring rubric may determine the manner in which points are added a score for responses exhibiting certain positive characteristics (or the manner in which points are deducted from a score for responses exhibiting certain negative characteristics). Such scoring rubrics may be created by a trained content expert, or otherwise according to methods described below.

The scoring model may specify one or more concepts that should be present (or sometimes absent) in order for a response to receive full credit or full points, or incremental credit or points, depending on the scoring rubric. For each of the concepts, various ways in which the concept can be expressed are determined. These various ways comprise model sentences that correspond to the concept and are used to determine if the concept is present in the response. The model sentences do not necessarily need to be proper sentences, but may comprise individual words, phrases, or various combinations of words.

Determining or calculating a real number probability that a concept is present in the response may be based on the individual probabilities that each of the model sentences is present in the response. The probability that a concept is present in a response may be calculated based upon the probability that each of its model sentences is present. An automatic system may read the response and, using natural language techniques, for instance, may calculate for each model sentence the probability that the model sentence is present in the response. These model sentence probabilities can then be used to determine the probability that a corresponding concept is present using various methods. For example, the probability that a concept is present may be approximated as the maximum probability that any one its model sentences is present in the response. Alternatively, any correlations between the presence of model sentences may be determined, and the probability that a concept is present can be determined based both on the individual probabilities that its model sentences are present and these correlations. These correlations may be determined or approximated through such means as a statistical analysis of various responses, and may be represented as conditional probabilities.

The scoring rule function may be created based on the scoring rubric, and may also be based on the presence or absence of various concepts. In one embodiment, each possible combination of the various concepts being present or absent in a response may represent a response vector. A score may be assigned to each response vector, such that given a response vector, the scoring rule gives a corresponding score (i.e. the score assigned to that response vector).

The expected value function generates a real number score based on the probabilities that individual concepts are present in the response. In one embodiment, the various probabilities associated with the possible presence of each concept may compose a probability vector. Based on the scoring rubric or scoring rules, the expected value function receives the probability vectors and outputs a real number score that may represent the probability that a given response is correct (such as in the case where the scoring rubric is binary, i.e., assigning one of two values to the response), or the “expected” score for the response that is an approximation of the likely score that the response should receive. In general, the expected value function may be given as:

$$g ( p ) = {\sum }_{u} f ( u ) P ( u ) = {\sum }_{u} ( f ( u ) {\prod }_{i = 1}^{n} ( {p}_{i}^{{u}_{i}} {q}_{i}^{1 - {u}_{i}} ) )$$

where the various functions, variables, and values are defined below.

In addition, the canonical formula for the scoring rule may be calculated. The canonical formula may be calculated by determining the expected value function, and then algebraically simplifying the expected value function in terms of the probability vector. The canonical formula for the scoring rule is the simplified expected value function in terms of the response vector in place of the probability vector. This canonical formula may then be checked against the scoring rule in order to determine its validity.

In another embodiment, the invention concerns a method of determining whether a concept is present in an essay based on the respective probabilities that individual model sentences are present in a response. One or more concepts having corresponding model sentences may be determined. An automatic system may then read the response and, using natural language techniques, for instance, may calculate for each model sentence the probability that the model sentence is present in the response. The probability that a concept is present in a response may be calculated based upon the probability that each of its model sentences is present in the response using various methods. For example, the probability that a concept is present may be approximated as the maximum probability that any one of its model sentences is present in the response. Alternatively, any correlations between the presence of model sentences may be determined, and the probability that a concept is present can be determined based both on the individual probabilities that its model sentences are present and these correlations. These correlations may be determined or approximated through such means as a statistical analysis of various responses.

In yet another embodiment, the invention concerns a method of validating an automated real number scoring system or model. The method generally comprises providing a multiplicity of responses, creating a scoring model having one or more concepts, determining for each response a probability that each concept is present in the response, creating a scoring rule function, determining an expected value function for the scoring rule function, generating a real number score for each response based on the expected value function, providing control scores for the responses, and comparing the real number scores to the control scores. The validation method may further include determining that the automated real number scoring system is valid if the real number scores are substantially similar to the control scores. The control scores may be generated by human scorers in accordance with the scoring rubric or scoring model.

The real number scores may be compared to the control scores by first rounding the real number scores to the nearest integer and then determining the degree of agreement between the different scores for the same response. Also, after rounding the real number scores to the nearest integer, the validity of the automated scoring system may be evaluated by calculating the quadratic kappa of the rounded real number scores with respect to the control scores. The scoring system or model may be determined to be reliable or valid if the quadratic kappa is greater than or equal to 0.7.

The real number scores may alternatively or additionally be compared to the control scores using a generalized quadratic kappa value. This generalized quadratic kappa may be calculated using the following formula:

$$κ = 1 - \frac{{\sum }_{k = 1}^{N} {( {s}_{k} - {t}_{k} )}^{2}}{{\sum }_{i = 1}^{n} ( {\sum }_{k = 1}^{N} {( i - {t}_{k} )}^{2} ) {r}_{i}}$$

where the various functions, variables, and values are defined below. This generalized quadratic kappa may be used to compare a continuous scoring method or model (such as using real number scores) to an integer or other fixed-step scoring scale, such as for the purposes of determining the validity or reliability of the continuous scoring method or model.

In yet another embodiment, the invention concerns a method for generating a real number scoring method or model. The method generally comprises creating a scoring model having one or more concepts, creating a scoring rule function, creating an expected value function for or from the scoring rule function, and determining the validity of the scoring method. Determining the validity of the scoring method may include providing a multiplicity of responses, generating a real number score for each response based on the expected value function, providing control scores for the responses, and comparing the real number scores to the control scores.

As noted above, the real number scores may be compared to the control scores by first rounding the real number scores to the nearest integer and then determining the degree of agreement between the different scores for the same response. Also, after rounding the real number scores to the nearest integer, the validity of the automated scoring system may be evaluated by calculating the quadratic kappa of the rounded real number scores with respect to the control scores. Alternatively or additionally, the real number scores may alternatively or additionally be compared to the control scores using the generalized quadratic kappa value.

In yet another embodiment, the above methods and manners may be implemented as a computer or computer system. The computer system may include a processor, a main memory, a secondary memory, and a display. The computer system may further include a secondary memory, input means (such as a mouse or keyboard), a display adapter, a network adapter and a bus. The bus may be configured to provide a communication path for each element of the computer system to communicate with other elements. Generally, the processor may be configured to execute a software embodiment of one or all of the above methods. The computer executable code may be loaded in the main memory for execution by the processor from the secondary memory. In addition to computer executable code, the main memory and/or the secondary memory may store data, including responses, textual content, essay scores, notations, and the like.

### BRIEF DESCRIPTION OF THE DRAWINGS

The invention is described below in connection with the following illustrative figures, wherein similar numerals refer to similar elements, and wherein:

FIG. 1 is a flow diagram of a method of generating a real number score for a response according to an embodiment of the invention;

FIG. 2 is a flow diagram of a method of generating a probability that a concept is present in a response;

FIG. 3 is a flow diagram of a method of determining the validity of a real number scoring method;

FIG. 4 is a flow diagram of a method of generating a real number scoring function for a real number scoring method; and

FIG. 5 is a block diagram of an architecture for an embodiment of an automated real number score generating application.

### DETAILED DESCRIPTION

For simplicity and illustrative purposes, the principles of the invention are described by referring mainly to an embodiment or embodiments thereof. In the following description, numerous specific details are set forth in order to provide a thorough understanding of the invention. It will be apparent however, to one of ordinary skill in the art, that the invention may be practiced without limitation to these specific details. In other instances, well-known methods and structures have not been described in detail so as not to unnecessarily obscure the invention.

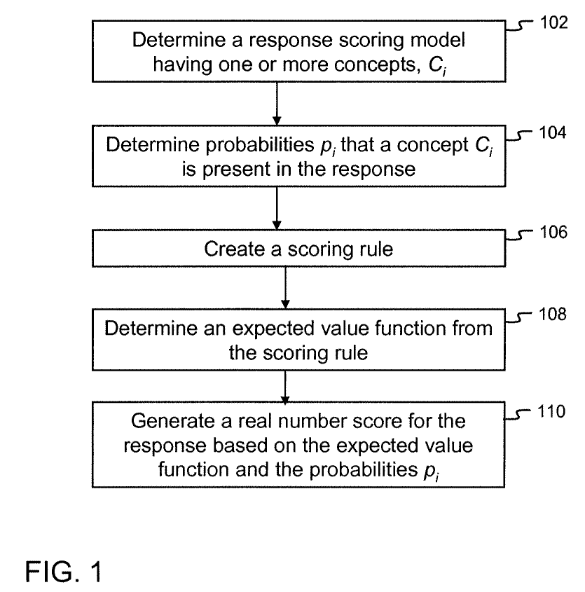

The following invention describes a method and application for scoring responses to constructed-response items based on the content of the response, generally without regard to the examinees' writing skills. FIG. 1 provides a flow diagram of a method of generating a real number score for a response according to an embodiment of the invention. At 102, someone or something (typically a specially-trained content expert) may construct a scoring model. This scoring model may be based on scoring rubrics provided by, for example, content experts. The scoring model specifies one or more concepts that must be present (or, sometimes, absent) for a response to receive full credit. The scoring model may also provide for each concept one or more model sentences that provide sufficient evidence that the concept is present in the response. As an example, a natural language processing technique may be used to analyze each response and determine if a paraphrase of a model sentence is present in the response.

The invention is described in-part in conjunction with the following examples. As a first example, the following item is a variant of a fourth-grade mathematics item from the National Assessment of Educational Progress:

A radio station wanted to determine the most popular type of music among those in the listening range of the station. Explain why sampling opinions at a country music concert held in the listening area would not be a good way to do this.

The scoring rubric for this item is fairly simple: 1 point if the examinee recognizes that the sample would be biased and 0 points otherwise. So the scoring model for this item would have one concept, that the sample would be biased. Based on a human-scored sample of examinees' responses, the model builder would identify various ways in which this concept is expressed by examinees, such as, for example, “They would say that they like country music.” The various ways in which the concept may be expressed form the model sentences corresponding to the concept. Methods for identifying and generating these model sentences are known to those having ordinary skill in the art and include, for example, identification or generation by specially-trained content experts or by specially adapted software.

The response is examined to determine the probability that a concept is present. A scoring rule is then applied to determine the score that is assigned to the response. In the case of the current example, the response is scored 1 point if the concept is present and 0 points otherwise.

Another example problem is provided that has a more complicated scoring rubric, along with a more complicated scoring model and scoring rule:

Name the U.S. presidents whose entire terms were between the two world wars.

The scoring rubric may be given in the following chart:

| Points | Rubric |
|---|---|
| 2 | At least two of the three correct presidents are named |
| | and no incorrect presidents are named. |
| 1 | At least two of the three correct presidents are named |
| | and also one or more incorrect presidents are named. |
| 1 | One correct president is named. |
| 0 | No correct presidents are named. |

The corresponding scoring model may then have four so-called concepts:

| Concept | Description |
|---|---|
| 1 | Warren G. Harding |
| 2 | Calvin Coolidge |
| 3 | Herbert Hoover |
| 4 | any incorrect president |

The model sentences in this model are not really sentences but names; concepts 1, 2, and 3 have one model sentence each and concept 4 has 39 model sentences, one for each president other than Harding, Coolidge, and Hoover (or maybe fewer if we only consider presidents' last names). The scoring rule assigns a score from 0 to 2, as follows:

2 points if two or three of concepts 1, 2, and 3 are present and concept 4 is not present.

1 point if two or three of concepts 1, 2, and 3 are present and concept 4 is also present.

1 point if one of concepts 1, 2, and 3 is present.

0 points otherwise.

It is worth noting that existing scoring models are generally deterministic in nature. They return only an affirmative response or a negative response depending on whether a model sentence is present. Thus, any probabilistic output is converted into a deterministic output by declaring that a paraphrase of the model sentence is present if p≧0.5 and is not present if p<0.5. Such scoring models do not provide information regarding the probability that concepts or scoring models are present. These probabilities may indicate, among other things, the level of confidence (or, equivalently, of uncertainty) with which it is determined the presence or absence of model sentences and, therefore, of concepts. This uncertainty may be obscured when the probabilities are rounded to 0 or 1 and are treated deterministically.

An alternative approach—utilized by this invention—is to calculate a score based on the probabilities themselves, and then to interpret this real-number score. Referring again to FIG. 1, at 104 the response is examined to determine the probability that each concept of the scoring model is present. These methods may include automatic analysis systems, which may use algorithms to determine that a concept is present based on keywords. Additionally or alternatively, methods may be used to analyze each response and determine if any of the sentences in the response is a paraphrase of one of the model sentences corresponding to a concept.

In one embodiment of the current invention, the probability pᵢⱼ that a form or paraphrase of the model sentence is present in the response is generated for each model sentence. This may include, for example, using known natural language techniques to analyze each sentence or segment of the response and to generate a probability that the sentence or segment discloses a concept.

The framework for using the probabilities associated with the presence or absence of concepts and/or model sentences is described in detail below.

To set the mathematical framework, it is assumed that a scoring model has n concepts C₁,C₂,K,Cₙ, and that each concept Cᵢ has mᵢ model sentences Sᵢ₁,Sᵢ₂,K,Sᵢₘ_{ᵢ}. For each i=1,K,n and j=1,K,mᵢ, uᵢⱼ is defined as follows:

$${u}_{ij} = \{ \begin{matrix}1 & if model sentence {S}_{ij} is present \\ 0 & if model sentence {S}_{ij} is not present\end{matrix}$$

Let pᵢⱼ=P(uᵢⱼ=1) and let pᵢ be the probability that concept Cᵢ is present. There are four problems that may be addressed

1. How can one compute each pᵢ from the pᵢⱼ's?

2. How can one use the scoring rubric to compute the real-number score from the pᵢ's?

3. How can one interpret the real-number scores?

4. How can one determine the reliability of the real-number scores?

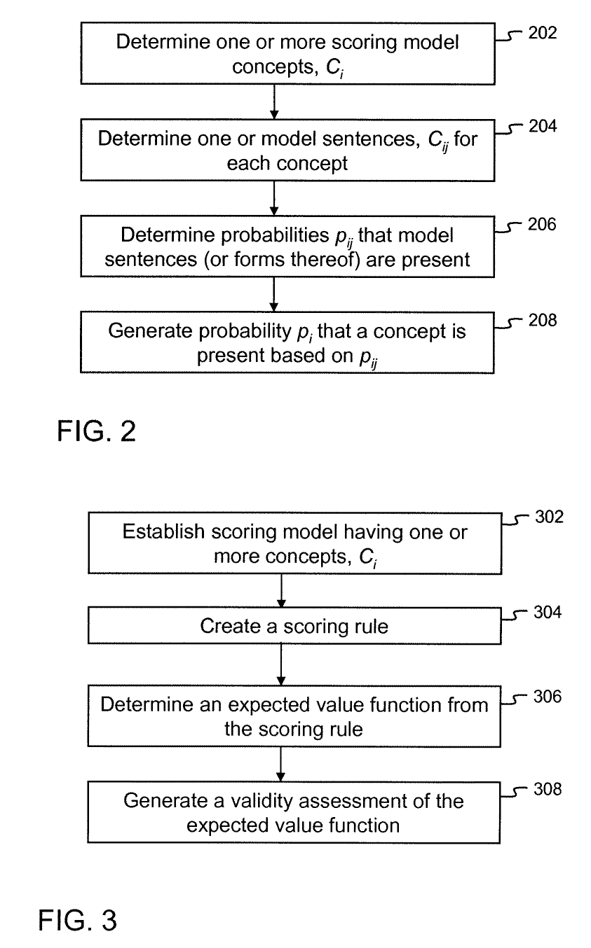

FIG. 2 is a flow diagram of a method of generating a probability that a concept is present in a response, according to an embodiment. At 202 and 204, respectively, a scoring model having one or more concepts Cᵢ and model sentences corresponding to the concepts are generated according to the techniques discussed herein. At 206, the probability that a form or paraphrase a model sentence is present in the response is generated for each model sentence, according to known methods. Again, this may include, for example, using known natural language techniques to analyze each sentence or segment of the response and to generate a probability that the sentence or segment discloses a concept. At 208, the probability pᵢ that a concept is present may be determined according to the following.

It may be assumed that concept Cᵢ is present if at least one of the model sentences is present, and therefore pᵢ equals the probability that uᵢⱼ=1 for at least one j=1,K,mᵢ. Alternatively, in more complex scoring models, Cᵢ may require the presence of multiple model sentences (i.e. that uᵢⱼ=1 for more than one j). Assuming the first case, however, if the presence of the various model sentences Sᵢ₁,Sᵢ₂,K,Sᵢₘ_{ᵢ} were independent events, then one could calculate pᵢ from the various pᵢⱼ's:

pᵢ=1−(1−pᵢ₁)(1−pᵢ₂)L(1−pᵢₘ_{ᵢ})

However, it may be the case that the presence of the model sentences are not independent, but instead are highly correlated. When one model sentence for a concept is present, it is often more likely that other model sentences for the same concept will also be present. It is possible to calculate pᵢ from the pᵢⱼ's if one also knows the conditional probabilities P(uᵢ₂=1|uᵢ₁=1) and so on.

Regardless of whether the conditional probabilities are known, if one assumes that the presence of the model sentences are highly correlated, then pᵢ can be reasonably approximated as the maximum of the pᵢⱼ's:

$${p}_{i} = {max}_{j = 1 , K , {m}_{i}} \{ {p}_{i 1} , K , {p}_{{im}_{i}} \} \qquad ( 1 )$$

Alternatively, one can calculate the various correlations and use them to create a model for the joint probability distributions. In one embodiment of the invention, the equation of (1) can be used to determine each pᵢ; modeling the joint probability distributions will be the subject of future research.

In one method, to use the pᵢ's to calculate the real-number score of a particular response, it is possible to define the following:

$${u}_{i} = \{ \begin{matrix}1 & if concept {C}_{i} is present \\ 0 & if concept {C}_{i} is not present\end{matrix}$$

for each i=1,K,n; then pᵢ=P(uᵢ=1). Let u=(u₁,u₂,K,uₙ); u is termed the response vector. A scoring model with n concepts has 2ⁿ different response vectors.

Referring again to FIG. 1, at 106 a scoring rule is generated. In this context, a scoring rule is a function f that assigns an integer score f(u) to each response vector u. The scoring rule for a particular scoring model may be based on the scoring rubrics for the item. For example, in the item above involving the U.S. presidents, the scoring model contains four concepts; therefore there are 16 different response vectors. The scoring rule f based on the scoring rubric is given in the following chart:

| U | f (u) |
|---|---|
| (0, 0, 0, 0) | 0 |
| (0, 0, 0, 1) | 0 |
| (0, 0, 1, 0) | 1 |
| (0, 0, 1, 1) | 1 |
| (0, 1, 0, 0) | 1 |
| (0, 1, 0, 1) | 1 |
| (0, 1, 1, 0) | 2 |
| (0, 1, 1, 1) | 1 |
| (1, 0, 0, 0) | 1 |
| (1, 0, 0, 1) | 1 |
| (1, 0, 1, 0) | 2 |
| (1, 0, 1, 1) | 1 |
| (1, 1, 0, 0) | 2 |
| (1, 1, 0, 1) | 1 |
| (1, 1, 1, 0) | 2 |
| (1, 1, 1, 1) | 1 |

In practice, f(u) will usually be a non-negative integer and f(0)=0, but in what follows it is not necessary to make this assumption. Referring again to FIG. 1, at 108 an expected value function is determined. The expected value function may be determined or generated according to the process of FIG. 3.

FIG. 3 is a flow diagram of a method of generating a real number scoring function for a real number scoring method. At 302 and 304, a scoring model having one or more concepts Cᵢ along with corresponding model sentences are generated according to the techniques discussed herein. At 306, the expected value function may be generated according to the following. Let p=(p₁,p₂,K,pₙ); p is termed a probability vector. A real-number score for the scoring rule f is a function g that assigns a real number score g(p) to each probability vector and that agrees with f on the response vectors, that is, g:Iⁿ→R and g(u)=f(u) for each response vector u.

Given f the function g can be defined. In essence, g is an extension of f to the unit n-cube Iⁿ, and any such extension will define a real number score. But such extensions are not unique; as described below, a scoring rule can have several possible extensions g, yielding different real number scores. Given an f it is also possible to determine a canonical extension of g.

If f is described by a formula that is defined on the entire unit n-cube, it is tempting to define g by the same formula (in effect, substituting p for u or, equivalently, each pᵢ for uᵢ). For example, the scoring rule for the U.S. presidents item can be given by the formula

f(u₁,u₂,u₃,u₄)=min(u₁+u₂+u₃,2−u₄) (2)

so it might be tempting to define the real number score for this item by

g(p₁,p₂,p₃,p₄)=min(p₁+p₂+p₃,2−p₄)

But since the same f can also be given by different formulas, yielding different g's, it is possible that this real number score may not be well-defined.

One approach is to define g to be the expected value of the scoring rule, given p. If we let qᵢ=P(uᵢ=0)=1−pᵢ, then it follows that

$$\begin{matrix}P ( {u}_{i} ) = \{ \begin{matrix}{p}_{i} & if {u}_{i} = 1 \\ {q}_{i} & if {u}_{i} = 0\end{matrix} \\ = {p}_{i}^{{u}_{i}} {q}_{i}^{1 - {u}_{i}}\end{matrix} \\ and therefore \\ P ( u ) = {\prod }_{i = 1}^{n} ( {p}_{i}^{{u}_{i}} {q}_{i}^{1 - {u}_{i}} ) \qquad ( 3 )$$

Where g(p) is defined to be the expected value of the scoring rule, it then follows from (3) that

$$g ( p ) = {\sum }_{u} f ( u ) P ( u ) = {\sum }_{u} ( f ( u ) {\prod }_{i = 1}^{n} ( {p}_{i}^{{u}_{i}} {q}_{i}^{1 - {u}_{i}} ) ) \qquad ( 4 )$$

Where v=(v₁,v₂,K,vₙ) is a particular response vector and p=v, so that pᵢ=vᵢ for each i, then for each i,

$${p}_{i}^{{u}_{i}} {q}_{i}^{1 - {u}_{i}} = \{ \begin{matrix}1 & if {u}_{i} = {v}_{i} \\ 0 & if {u}_{i} \neq {v}_{i}\end{matrix}$$

and hence by (3)

$$P ( u ) = \{ \begin{matrix}1 & if u = v \\ 0 & if u \neq v\end{matrix}$$

It then follows from (4) that g(v)=f(v). Thus g is an extension of f. Accordingly, the function of (4) may be used to generate an expected value function g from the scoring rule. Additionally, the validity of the expected value function may be determined at 308 using a validity quotient, such as a generalized quadratic kappa function, as described below.

Referring again to FIG. 1, once the expected value function has been determined, a real number score may be generated at step 110 based on the probabilities pᵢ that the various concepts are present. As an example, the case n=1 is considered. In this case there is only one concept and one response “vector” u, which equals 1 if the concept is present and 0 if the concept is not present. In this case there is probably only one reasonable scoring rubric—assign a score of 1 if the concept is present and a score of 0 if the concept is not present; in other words, f(1)=1 and f(0)=0. This is the scoring model for the NAEP variant item discussed above. Note that f can be described by the formula f(u)=u. If p is the probability that the concept is present, then the real number score is

g(p)=1·p+0·(1−p)=p

Thus, in this case the real number score can be obtained by substituting p for u in the formula for the scoring rule. But note that, if f is defined differently, such as f(u)=u², then the scoring rule is the same—f(0)=0 and f(1)=1—and so is real number score, but the real number score does not equal f(p). Thus the real number score must be obtained by substituting p for u in the “right” formula for the scoring rule.

Next, the case n=2 is considered for illustrative purposes. In this case there are two concepts, C₁ and C₂. Below are three possible scoring rules:

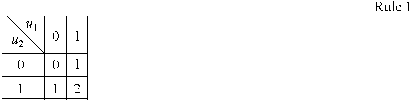

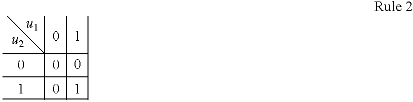

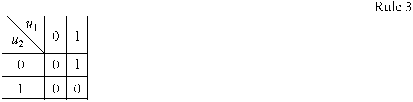

In the first rule, the score is the number of concepts present; if both concepts are present in a response, then the response receives a score of 2, while if only one concept is present, the response receives a score of 1. In the second rule, the response receives a score of 1 if both concepts are present; otherwise, the response receives a score of 0. In the third rule, the response receives a score of 1 if the first concept is present unless the second concept is also present, in which case the response receives a score of 0. These scoring rules can be expressed by the following formulas:

f₁(u₁,u₂)=u₁+u₂ f₂(u₁,u₂)=u₁u₂ f₃(u₁,u₂)=max(u₁−u₂,0)

For each of the above rules, the real number score is

$$\begin{matrix}g ( {p}_{1} , {p}_{2} ) = f ( 0 , 0 ) {p}_{1}^{0} {q}_{1}^{1} {p}_{2}^{0} {q}_{2}^{1} + f ( 1 , 0 ) {p}_{1}^{1} {q}_{1}^{0} {p}_{2}^{0} {q}_{2}^{1} + \\ f ( 0 , 1 ) {p}_{1}^{0} {q}_{1}^{1} {p}_{2}^{1} {q}_{2}^{0} + f ( 1 , 1 ) {p}_{1}^{1} {q}_{1}^{0} {p}_{2}^{1} {q}_{2}^{0} \\ = f ( 0 , 0 ) {q}_{1} {q}_{2} + f ( 1 , 0 ) {p}_{1} {q}_{2} + f ( 0 , 1 ) {q}_{1} {p}_{2} + \\ f ( 1 , 1 ) {p}_{1} {p}_{2}\end{matrix} \qquad ( 5 )$$

For the first rule, (5) becomes

$$\begin{matrix}g ( {p}_{1} , {p}_{2} ) = 0 \cdot {q}_{1} {q}_{2} + 1 \cdot {p}_{1} {q}_{2} + 1 \cdot {q}_{1} {p}_{2} + 2 \cdot {p}_{1} {p}_{2} \\ = {p}_{1} ( 1 - {p}_{2} ) + ( 1 - {p}_{1} ) {p}_{2} + 2 {p}_{1} {p}_{2} \\ = {p}_{1} + {p}_{2}\end{matrix}$$

For this rule, the real number score can be obtained by substituting the pᵢ's for the uᵢ's in the formula for the rule f₁. But again, the “right” formula must be used to generate the real number score; the formula f(u₁,u₂)=u₁²+u₂² gives the same scoring rule, and therefore the same real number score g(p₁,₂), but g(p₁,p₂)≠f(p₁,p₂).

For the second rule, (5) becomes

$$\begin{matrix}g ( {p}_{1} , {p}_{2} ) = 0 \cdot {q}_{1} {q}_{2} + 0 \cdot {p}_{1} {q}_{2} + 0 \cdot {q}_{1} {p}_{2} + 1 \cdot {p}_{1} {p}_{2} \\ = {p}_{1} {p}_{2}\end{matrix}$$

Again the real number score can be obtained by substituting the pᵢ's for the uᵢ's in the formula for the rule f₂.

For the third rule, (5) becomes

$$\begin{matrix}g ( {p}_{1} , {p}_{2} ) = 0 \cdot {q}_{1} {q}_{2} + 1 \cdot {p}_{1} {q}_{2} + 0 \cdot {q}_{1} {p}_{2} + 0 \cdot {p}_{1} {p}_{2} \\ = {p}_{1} ( 1 - {p}_{2} )\end{matrix}$$

In this example, the real number score cannot be obtained by substituting the pᵢ's for the uᵢ's in the formula for f₃ given earlier, but what this means is that the formula for f₃ is the “wrong” formula; we should have defined f₃(u₁,u₂)=u₁(1−u₂). One can check that this formula for f₃ describes the same scoring rule.

In general, the canonical formula for a scoring rule can be found by algebraically simplifying the expected value of the scoring rule. For example, the scoring rule table for the U.S. presidents item can be extended to calculate the expected value:

| u | f (u) | P (u) | f (u) · P (u) |
|---|---|---|---|
| (0, 0, 0, 0) | 0 | q₁q₂q₃q₄ | 0 · q₁q₂q₃q₄ |
| (0, 0, 0, 1) | 0 | q₁q₂q₃p₄ | 0 · q₁q₂q₃p₄ |
| (0, 0, 1, 0) | 1 | q₁q₂p₃q₄ | 1 · q₁q₂p₃q₄ |
| (0, 0, 1, 1) | 1 | q₁q₂p₃p₄ | 1 · q₁q₂p₃p₄ |
| (0, 1, 0, 0) | 1 | q₁p₂q₃q₄ | 1 · q₁p₂q₃q₄ |
| (0, 1, 0, 1) | 1 | q₁p₂q₃p₄ | 1 · q₁p₂q₃p₄ |
| (0, 1, 1, 0) | 2 | q₁p₂p₃q₄ | 2 · q₁p₂p₃q₄ |
| (0, 1, 1, 1) | 1 | q₁p₂p₃p₄ | 1 · q₁p₂p₃p₄ |
| (1, 0, 0, 0) | 1 | p₁q₂q₃q₄ | 1 · p₁q₂q₃q₄ |
| (1, 0, 0, 1) | 1 | p₁q₂q₃p₄ | 1 · p₁q₂q₃p₄ |
| (1, 0, 1, 0) | 2 | p₁q₂p₃q₄ | 2 · p₁q₂p₃q₄ |
| (1, 0, 1, 1) | 1 | p₁q₂p₃p₄ | 1 · p₁q₂p₃p₄ |
| (1, 1, 0, 0) | 2 | p₁p₂q₃q₄ | 2 · p₁p₂q₃q₄ |
| (1, 1, 0, 1) | 1 | p₁p₂q₃p₄ | 1 · p₁p₂q₃p₄ |
| (1, 1, 1, 0) | 2 | p₁p₂p₃q₄ | 2 · p₁p₂p₃q₄ |
| (1, 1, 1, 1) | 1 | p₁p₂p₃p₄ | 1 · p₁p₂p₃p₄ |

The expected value g(u₁,u₂,u₃,u₄)is the sum of the entries in the fourth column. Using a bit of algebra, it is possible to show that

g(p₁,p₂,p₃,p₄)=p₁+p₂+p₃−p₁p₂p₃−p₁p₂p₄−p₁p₃p₄−p₂p₃p₄+2p₁p₂p₃p₄ (6)

and therefore the canonical formula for this scoring rule is

f(u₁,u₂,u₃,u₄)=u₁+u₂+u₃−u₁u₂u₃−u₁u₂u₄−u₁u₃u₄−u₂u₃u₄+2u₁u₂u₃u₄ (7)

Accordingly, (7) is the same scoring rule as (2).

The real number score can then be interpreted in terms of the original scoring rubric. For example, for the U.S. presidents item, if the analysis of the response returns the following concept-level probabilities:

p₁=0.8

p₂=0.6

p₃=0.4

p₄=0.2

then the real number score for this response is 1.4768. The significance of this value can be determined with respect to the scoring rubric as follows.

For the NAEP variant, the real number score is quite transparent; there is only one concept, the item is being scored right or wrong, according to whether the concept is present or not, and the real number score of a response is just the probability that the response is correct.

For the three 2-concept rules, the situation is only a little more complicated. First consider Rule 2. As with the NAEP item, a response is scored right or wrong; the response is scored right if both concepts are present and wrong otherwise. The probability that the first concept is present is p₁ and the probability that the second concept is present is p₂. It follows that the real number score g(p₁,p₂)=p₁p₂ is the probability that both concepts are present; i.e., the probability that the response is correct.

The situation with Rule 3 is similar, except that here a response is scored right if the first concept is present and the second concept is not present, and wrong otherwise. The real number score g(p₁,p₂)=p₁(1−p₂) is the probability that the first concept is present and the second one is not; i.e., the probability that the response is correct.

With Rule 1, two concepts must be present in a response for the response to receive full credit (2 points); if only one concept is present, the response receives 1 point. In this case, the real number score g(p₁,p₂)=p₁+p₂ is a number between 0 and 2. It cannot be interpreted as the probability of a correct response, but it can be interpreted as an “expected” score for the response. For example, if p₁=0.5 and p₂=0.5, then the real number score is 1. If there is a 50% chance that the first concept is present in the response and there is also a 50% chance that second concept is present, then the most likely event is that one of the two concepts is present. With real number scoring, we can assign a score of 1 without determining which of the two concepts is present. If p₁=0.6 and p₂=0.6, then there is a greater than 50% chance that each concept is present; this is reflected in the fact that the real number score, 1.2, is greater than 1.

For the U.S. presidents item, it will be easier to interpret the real number score by rewriting the scoring rule (7) as

f(u₁i ,u₂,u₃,u₄)=u₁+u₂+u₃−u₁u₂u₃−(u₁u₂+u₁u₃+u₂u₃−2u₁u₂u₃)u₄ (8)

The sum of the first three terms of (8), u₁+u₂+u₃, equals the number of correct presidents present in the response. The fourth term, u₁u₂u₃, equals 0 unless all three correct presidents are present, in which case this term equals 1. Thus the difference

u₁+u₂+u₃−u₁u₂u₃ (9)

equals the number of correct presidents present unless all three correct presidents are present, in which case (9) equals 2.

The term u₁u₂ equals 0 unless concepts 1 and 2 are present, in which case this term equals 1. Similarly, u₁u₃ equals 1 or 0 according to whether concepts 1 and 3 are both present, and similarly for u₂u₃. Note that if two of these terms equal 1, then so does the third. Thus the sum u₁u₂+u₁u₃+u₂u₃ equals 0, 1, or 3, according to whether there are 0 or 1 of the first three concepts present, exactly 2 present, or all three present. Since 2u₁u₂u₃ equals 2 if all of the first three concepts are present and 0 otherwise, it follows that the difference u₁u₂+u₁u₃+u₂u₃−2u₁u₂u₃ equals 1 if two or three of the first three concepts are present and 0 otherwise. Therefore the product

(u₁u₂+u₁u₃+u₂u₃−2u₁u₂u₃)u₄ (10)

equals 1 if two or three of the first three concepts are present and the fourth concept is present, and 0 otherwise. Subtracting (10) from (9), therefore, has the effect of imposing the one-point penalty for the presence of an incorrect president when two or three correct presidents are present.

Along the lines of (8), the formula for the real number score (6) can be rewritten

g(p₁,p₂,p₃,p₄)=p₁+p₂+p₃−p₁p₂p₃−(p₁p₂+p₁p₃+p₂p₃−2p₁p₂p₃)p₄

The previous example g(0.8, 0.6, 0.4, 0.2)=1.4768 can now be interpreted as an expected score.

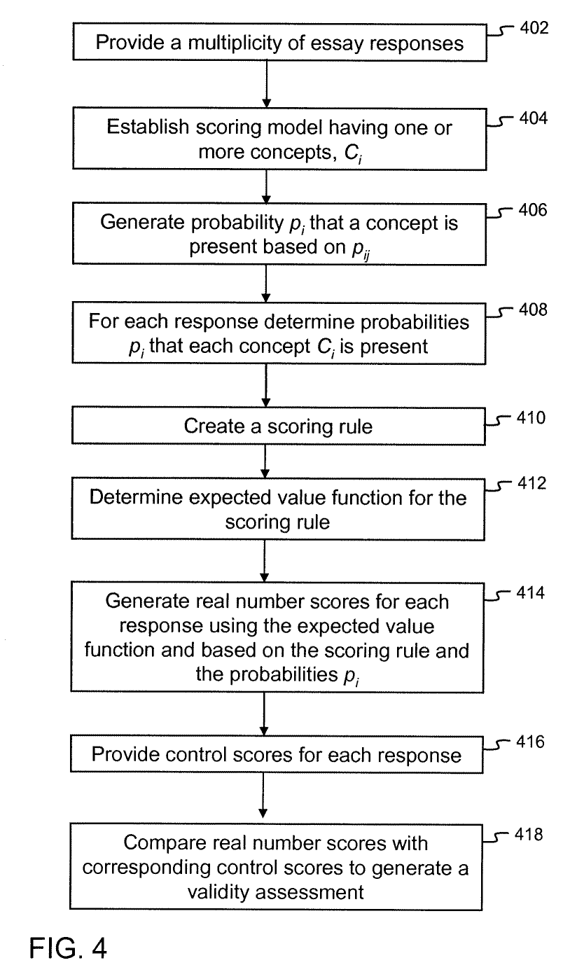

As noted above, once a scoring model has been written it can be used to score responses. FIG. 4 is a flow diagram of a method of determining the validity of a real number scoring method, such as the one described above. At 402, a multiplicity of essay responses is provided. In steps 404-414, a real number scoring method is created and applied to the essay responses to generate real number scores, in accordance with the methods and techniques described above. In the case of developing an automated scoring algorithm or system, the scoring model may be used to score the provided sample of responses which, at 416, have also been human scored according to the scoring rubric. The automated scoring system scores are then compared with the human scores and the inter-rater reliability can be determined by calculating the quadratic-weighted kappa, κ, and other statistical measures. If κ<0.7, the scoring model is deemed too unreliable for automated scoring.

It is possible to determine if the real number scores more reliable than integer scores by a comparison of the scores, as in step 418. One approach is to calculate integer scores and real number scores for a sample of responses for which we have human scores, round the real number score to the nearest integer, and calculate the quadratic kappa. Another approach is to generalize the quadratic kappa to apply to the human/real-number agreement.

In general, N responses may be human-scored on an n-point integer scale, such as a scale from 1 to n, to generate N control scores. If an automatic or other scoring method is used to score the responses on an n-point integer scale, then the quadratic kappa is defined as follows:

For i=1,K, n and j=1,K, n, let

aᵢⱼ=the number of responses scored i by the human rater and scored j by c-rater

Rᵢ=the number of responses scored i by the human rater

Cⱼ=the number of responses scored j by c-rater

$${b}_{ij} = \frac{{R}_{i} {C}_{j}}{N}$$

The quadratic kappa is then given by

$$κ = 1 - \frac{{\sum }_{i = 1}^{n} {\sum }_{j = 1}^{n} {( i - j )}^{2} {a}_{ij}}{{\sum }_{i = 1}^{n} {\sum }_{j = 1}^{n} {( i - j )}^{2} {b}_{ij}} \qquad ( 11 )$$

However, this formula may not necessarily apply in the case where the automatic or other scoring method returns real number scores, such as in the methods described above. Accordingly, another method for comparing real number scores with corresponding control scores is as follows. Let k=1,K, N denote the N responses that are scored, and let tₖ be the real number score assigned to response k by the real number scoring method. Then while the real number scoring method is theoretically scoring on a continuous scale, in fact it has scored the responses on the unordered scale t₁,t₂,K,t_{N}, where the number of responses scored at any score point is indicated by the number of occurrences of that score point in this list. Thus each of the score points tₖ represents the real number score of a single response, namely response k.

In (11) j can be replaced by tₖ, aᵢⱼ can be replaced by aᵢₖ, where aᵢₖ is the number of responses scored i by the human rater and scored tₖ by c-rater, and bᵢⱼ can be replaced with

$${b}_{ik} = \frac{{R}_{i} {C}_{k}}{N} ,$$

where Cₖ is the number of responses scored tₖ by c-rater. Let sₖ be the (integer) score assigned to response k by the human reader. Since response k is the only response whose real number score is represented by tₖ, it follows that

$${a}_{ik} = \{ \begin{matrix}1 & if i = {s}_{k} \\ 0 & if i \neq {s}_{k}\end{matrix}$$

Therefore (i−tₖ)² aᵢₖ=(sₖ−tₖ)² and hence the numerator of the fraction in (11) becomes

$${\sum }_{k = 1}^{N} {( {s}_{k} - {t}_{k} )}^{2} .$$

Since Cₖ=1, it follow that bᵢₖ=rᵢ, where

$${r}_{i} = \frac{{R}_{i}}{N}$$

is the proportion of responses scored i by the human rater. Thus the denominator of the fraction in (11) becomes

$${\sum }_{i = 1}^{n} ( {\sum }_{k - 1}^{N} {( i - {t}_{k} )}^{2} ) {r}_{i} ,$$

and therefore our formula for the generalized quadratic kappa is

$$κ = 1 - \frac{{\sum }_{k = 1}^{N} {( {s}_{k} - {t}_{k} )}^{2}}{{\sum }_{i = 1}^{n} ( {\sum }_{k = 1}^{N} {( i - {t}_{k} )}^{2} ) {r}_{i}}$$

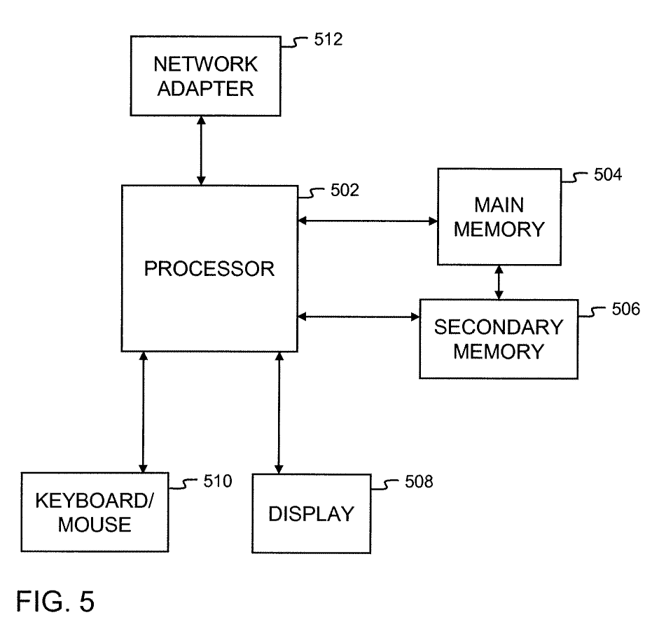

The above methods and manners may be implemented as a computer or computer system. FIG. 5 is a block diagram of an architecture for an embodiment of an automated real number score generating application. The computer system 500 may include a processor 502, a main memory 504, a secondary memory 506, and a display 508. The computer system may further include a secondary memory 506, input means 510 (such as a mouse or keyboard), a display adapter, a network adapter (512) and a bus. The bus may be configured to provide a communication path for each element of the computer system to communicate with other elements. Generally, processor 502 may be configured to execute a software embodiment of one or all of the above methods. The computer executable code may be loaded in main memory 504 for execution by the processor from secondary memory 506. In addition to computer executable code, the main memory and/or the secondary memory may store data, including responses, textual content, essay scores, notations, and the like.

In operation, based on the computer executable code for an embodiment of the above methods, the processor may generate display data. This display data may be received by the display adapter and converted into display commands configured to control the display. Furthermore, in a well-known manner, mouse and/or keyboard 510 may be utilized by a user to interface with the computer system.

Network adapter 512 may be configured to provide two-way communication between the network and the computer system. In this regard, the above methods and/or data associated with the above methods, such as responses and response scores, may be stored on a network and accessed by the computer system.

Automated Content Scoring of Free-Text with c-rater

Traditionally, assessment depended on multiple choice items. Now, the education community is moving towards constructed or free-text responses. (We use the terms “responses” and “answers” interchangeably.) Also, it is moving to a widespread computer-based assessment At the same time, progress in natural language processing (NLP) and knowledge representation (KR) has made it possible to consider free-text responses without having to fully understand the text. c-rater (Leacock & Chodorow 2003) is a technology at Educational Testing Service (ETS) for automatic content scoring for short free-text responses. This paper describes the developments made in c-rater since 2003. Unlike most automatic content scoring systems, c-rater considers an analytic-based content This means that a c-rater item consists of (in addition to a prompt and an optional reading) a set of clear, distinct, predictable, main/key points or concepts, and the aim is to score students' answers automatically for evidence of what a student knows vis-à-vis these concepts. See items in Table 1 for examples. For each item, there are corresponding concepts in the right-hand column that are denoted by C1, C2, . . . Cn where n is a concept number. These are also separated by semicolons for additional clarity. The number of concepts, N, is included in the heading Concepts:N. The scoring guide for each item is based on those concepts. Note that we deal with items whose answers are limited to 100 words each.

In the section “c-rater in a nutshell”, we describe c-rater's task in terms of NLP and KR, how c-rater works, that is, the solution we undertake for that task, and the major changes in the NLP components since 2003. In section “Scoring Design and Computation”, we describe the scoring method that we believe will allow c-rater to improve the accuracy of its scores and feedback, various scoring computations that we experimented with to explore the possibility of improving c-rater's scores in terms of human agreement. We then discuss some of our limitations and consequentially the need to introduce deeper semantics and an inference engine into c-rater. Before we conclude, we briefly summarize others' work on automatic content scoring.

c-rater in a Nutshell

We view c-rater's task as a textual entailment problem (TE). We use TE here to mean either:

a paraphrase

an inference up to a context (There are reasons why we differentiate between a paraphrase and an inference in the definition, though a paraphrase is an inference of itself, but we will not go into details here).

For example, consider item 4 in Table 1. An answer like “take the colonists' side against England” is the same as C2, an answer like “the dispute with England is understood” is a paraphrase of C1 and an answer like “The colonists address the crowd. They say Oh Siblings!” implies C4. Note that in this case the word siblings is acceptable while an answer like “My sibling has a V Chromosome” for the concept “My brother has a V chromosome” is not acceptable. The context of the item is essential in some cases in determining whether an answer is acceptable; hence, we say up to a context in the definition above.

c-rater's task is reduced to a TE problem in the following way:

Given: a concept, C, (for example, “body increases its temperature”) and a student answer, A, (for example either “the body raise temperature”, “the bdy responded. His temperature was 37° and now it is 38°” or “Max has a fever”) and the context of the item the aim is to check whether C is an inference or a paraphrase of A (in other words A implies C and A is true)

Having such a task we attempt to solve it as follows: the set of students' answers for a particular item is divided between training data and blind (testing) data. Then a linguistic analysis (we describe below) is performed on every answer in the training data and a scoring model is built (as we describe in section “model building: knowledge engineering approach”) with its corresponding statistical analysis (including kappa agreement between human scores and c-rater scores). If results on kappa are not satisfying then the process of model building will iterate until agreement is satisfying. Once it is, unseen data is scored. For each unseen answer, a similar linguistic analysis is performed, and the linguistic features in the answer are compared to those in the model. Scoring rules then are applied to obtain a score.

Linguistic Analysis: c-rater and NLP

Student data is noisy; that is, it is fill of misspellings and grammatical mistakes. Any NLP tool that we depend on should be robust enough towards noise. In the following, we describe the stages that a student answer and a model answer go through in terms of processing in c-rater. Spelling correction is performed as a first step in an attempt to decease the noise for subsequent NLP tools.

In the next stage, part of speech tagging and parsing are performed. c-rater used to have a partial passer, Cass, (Abney 1991), which uses a chunk-and-clause parsing way where ambiguity is contained; for example a prepositional phrase (PP) attachment is left unattached when it is ambiguous. Cass has been designed for large amounts of noisy text. However, we observed that the degree of noise varies from one set of data to another (in our space of data) and in an attempt to gain additional linguistic features, a deeper parser was introduced (OpenNLP parser, Balcridge and Morton available at opeenlp.sourceforge.net) instead of Cass. Though no formal evaluation has been performed, a preliminary one on some Biology and Reading comprehension data revealed that the parser is robust enough towards noise, but in some cases the error rate is not trivial.

In the third stage, and risking losing information from a parse tree, a parse is reduced to a flat structure representing phrasal chunks annotated with some syntactic and semantic roles. The structure also indicates the links between various chunks and distributes links when necessary. For example, if there is a conjunction, a link is established.

The next stage is an attempt to resolve pronouns and definite descriptions. Hence, the body in the body raises temperature is resolved to an animal's body (this appears in the prompt of the item). Once this is done, a morphological analyzer reduces words to their stems.

The final step is the matching step. Given a model sentence like increase temperature with synonym (increase)=raise then the same processing takes place and a probability on the match is obtained from a model trained using Maximum entropy modeling. c-rater's matching algorithm, Goldmap, used to be rule-based giving a 0/1 match Though rule-based approaches are more transparent and easier to track, they are not flexible. Any amount of “uncertainty” (which is the case when extracting linguistic features from a text; let alone noisy text) will always imply failure on the match. A probabilistic approach, on the other hand, is “flexible”. That said, a probabilistic approach is not as transparent, and it lends itself to the usual questions about which threshold to consider and whether heuristics are to be used. We will see this in section “Threshold Adjustment” below.

### Scoring Design and Computation

### Concept-Based Scoring

c-rater's scoring now depends also on an analytic model and not only a “holistic” one as it used to be until recently. This means that the model is based on analytic or concept-based scores and human annotated data. We call this concept-based scoring. The motivation behind concept-based scoring has many aspects. First, trying to have a one-to-one correspondence between human analytic annotations (will be described next) and a concept will minimize the noise in the data. This should make the job for a model builder easier and automating model building, which is laborious and time consuming, should also be easier. Further, we expect better accuracy with which the matching algorithm decides about whether Concept C is a TE of Answer A since it is learning from a much more accurate set of linguistic features about the TE task than it does without this correspondence. A similar idea has been used in the OXFORD-UCLES system (Sukkarieh & Pulman 2005) where even a Naive Bayes learning algorithm applied to the lexicon in the answers produced a high quality model from a tighter correspondence between a concept and the portion of the answer that deserves 1 point/mark.

The study that we conducted can be summarized as follows. Consider items 3 and 4 in Table 1 with 24 and 11 concepts, respectively, with 500 answers as training data and 1000 as blind data for each. Two human raters were asked to annotate and score the data according to the concepts, and the c-rater's model building process is re-implemented to be driven by these concepts. Once a concept-based model is built, the unseen data is scored. These steps will be explained below.

### Human Annotation and Scoring

Given the students' answers, we asked the human raters to annotate the data. We provided a scoring form for the human raters with which to annotate and score the answers of the items. By annotation, we mean for each concept we ask them to quote the portion from a student answer that says the same thing as, or implies, the concept in the context of the question at hand. For example, assume a student answers item 1 by This is an easy process. The body maintains homeostasis during exercise by releasing water and usually by increasing blood flow. For C4:sweating, the human rater quotes releasing water. For C6:increased circulation rate, the rater quotes increasing blood flow.

For every item, a scoring form was built. The concepts corresponding to the item were listed in the form and for each answer the rater clicks on 0 (when a concept is absent),+(when a concept is present) or − (when a concept is negated or refuted) for each concept. 0, +, −are what we call analytic or concept-based scores and not the actual scores according to the scoring rules. When a concept is present or negated, the raters are asked to include a quote extract from the student's answer to indicate the existence or the negation of the concept Basically, the raters are asked to extract the portion of the text P that is a paraphrase or implies the concept, C, (when the concept is present) and the portion of text P such that P=neg(C) (when the concept is negated). We call a quote corresponding to concept C positive evidence or negative evidence for +and −, respectively (When we say evidence we mean positive evidence). Note that portions corresponding to one evidence do not need to be in the same sentence and could be scar over a few lines. Also, we observed that sometimes there was more than one evidence for a particular concept. Further, due to the nature of the task some cases were subjective (no matter how objective the concepts are, deciding about an implication in a context is sometimes subjective). Hence, annotation is a challenging task Also, human raters were not used to scoring analytically which made the task more difficult for them (but they found the scoring form very friendly and easy to use).

Looking at data, we observed that in the same way humans make mistakes in scoring, they make mistakes in annotation. Inconsistency in annotation existed. In other instances, we found evidence under the wrong concept or the same evidence under two different concepts, or some concepts had no evidence at all. In addition, humans sometimes agreed on a score or the presence of evidence but disagreed on the evidence. We noted also that humans chose the same evidence in various places to indicate presence and refutation at the same time. Finally, some incorrect technical knowledge on behalf of the student was accepted by human raters.

### Model Building: Knowledge-Engineering Approach

The model building process was and still is a knowledge-engineered process. However, now it depends on the concepts and the evidence obtained by the above annotation, and consequently Alchemist, the model building user interface, and c-rater's scoring engine have been re-implemented to deal with concept-based scoring.

In Alchemist, a model builder is provided with: a prompt/question, key points/concepts, scoring rules, analytically scored data from two humans, analytically annotated data and total scores for each answer. For each concept the model builder produces a tree where each child node is an essential point and each child of an essential point is a model sentence. For example, for item 1 above, consider C4:sweating:

### Concept: Sweating

Essential point: sweating
Model sentence 1: sweating
synonym(sweat): {perspire}
Model sentence 2: to release moisture
synonym(release): {discharge, etc}
Model sentence 3: to exude droplets

A model builder also chooses a set of key lexicon and their synonyms in each model sentence. These are considered by Goldmap the highest-weighted lexicon in the model sentences when trying to match an answer sentence to a model sentence. Basically, a model builder's job is to find variations that are paraphrases or could imply the concept (guided by the evidence provided by hum raters—usually a model sentence is an abstraction of several instances of evidence). It is not just about having the same words, but finding or predicting syntactic and semantic variations of the evidence. Currently, the only semantic variation is guided by a synonymy list provided to the model builder. The model consists of the set of concepts, essential points, model sentences, key lexicon and their synonyms (key lexicon could be words or compounds) and scoring rules.

### Evaluation

Table 2 shows the results, in terms of unweighted kappas, on items 3 and 4. The results were very promising considering that this is our first implementation and application for concept-based scoring. (We really believe the success of c-rater or any automated scoring capability should not be judged solely by agreement with human raters. It should be guided by it but the main issue is that whether the results obtained are for the right reasons and whether they are justifiable.) The results of the Biology item were better than that of the English item. Linguistically, the concepts in the Biology item were easier and more constrained For the Biology item the concept that c-rater had trouble with was CI 7:diarrhea, the main reason we noticed was the unpredictability in the terms that students used to convey this concept (we leave it to your imagination). For the English item, the problematic concepts were mostly the how concepts. These proved to be ambiguous or more open for interpretation, for example, CS: Use authoritative language was not clear as to whether students are expected to write something similar or to quote from the text. When students did quote the text, examiners did not seem to agree whether that was authoritative or not!

Agreement with H2 (Human 2) was much worse than agreement with H1 (Human 1). In case of the Biology item, we observed that H2 made a lot of mistakes scoring. However, we have no hypothesis for the results on the English item except that these results were consistent with the results on the training data. Note also that H is a representative symbol of more than one rater which makes the consistency in the observation and the results puzzling. The main reasons observed for the failure of a match by c-rater (and consequently a lower agreement) varied from:

Some concepts were not distinct or ‘disjoint’ for example C:high temperature implied C:being ill

uncorrected spelling mistakes (or sometimes corrected to an unintended word)

unexpected synonyms, unexpected variations that a human did not predict phenomena we do not deal with (e.g. negation)

the need for a reasoning/inference module

the fact that some model sentences are too general and have generated false positives (negative evidence was used as a guidance to minimize this generation)

Our next application for concept-based scoring will be conducted with items that are driven by basic reading comprehension skills and are more suitable for automated scoring.

### Scoring Computation

In addition to conducting our study on concept-based scoring, we attempted to answer some questions about the threshold used to determine a match, real number scoring as opposed to integer scoring, obtaining a confidence measure with a c-rater score and feedback. The threshold adjustment and real number scoring only will be explained in the following sections.

### Threshold Adjustment

Goldmap, as mentioned above, outputs a probabilistic match for each sentence pair (Model Sentence, Answer Sentence); a threshold of 0.5 was originally set for deciding whether there is a match or not The questions to answer are whether 0.5 is the optimal threshold, whether to find the thresholds that will maximize concept kappas for each concept and whether these optimized thresholds will make a significant difference in the scores or not.

The goal then is to get the vector of thresholds that corresponds to the vector of optimized concept level kappa values across all concepts:

<T₁, T₂, . . . Ti, . . . , Tn,>corresponding to

<Cka₁, Cka₂, . . . , Ckaᵢ, . . . , Ckaₙ>

where Ckaᵢ is a concept level kappa for concept i at threshold Tᵢ and n is the number of concepts.

The approach we take is summarized as follows. An algorithm that gives the model builder the maximum concept kappa value across different pre-determined thresholds and spell out that threshold is to be built in c-rater. Next, the model builder will change the model to optimize the concept kappa for that concept:

Cka_{OPT}=OPT(<Cka₁, Cka₂, . . . , Ckaᵢ, . . . , Ckaₙ>)

then once a model builder believes s/he has Cka_{OPT}, s/he can, if needed, move to the next iteration in model building and the process of finding maximum kappa values is repeated and so on.

Instead of initializing the set of potential thresholds (in which an optimal will be found), T, by considering say a lower bound, an upper bound and an increment, the aim is to link T to Goldmap, the actual algorithm the probabilities are obtained from. Hence, we set T to denote

$$T = \{ \frac{{p}_{2} - {p}_{1}}{2} , K , \frac{{p}_{n} - {p}_{n - 1}}{2} \} ⋃ \{ 0 , 1 , 0.5 \}$$

Currently, a maximum of 30 distinct probabilities for a particular item are obtained from Goldmap and hence the current algorithm to find maximum concept kappas is efficient. However, if and when Goldmap will output a large number of distinct probabilities (in the hundreds or thousands if it is fine-grained enough) we may have to look at the probability distribution and Z-score. There is also an issue of “concept kappas vs total kappas” but we will not discuss here.

### Real Number Scoring

Given a certain threshold each probability is transformed into a Match/NoMatch or 0/1 and subsequently the scoring rules are used to calculate a score. However, instead of transforming probabilities and losing accuracy we attempt to answer yet another question, namely, will keeping the probabilities as they are and seeking a real number score (RNS) instead make a significant difference? The claim is that the real number scores are more reliable than the integer scores that we used to calculate and the hypothesis to test is whether Pearson's correlation between humans and RNSs is higher than the correlation between integer scores and humans. The subtasks that we had to tackle and the solutions we currently consider are as follows:

A probability is obtained on a (model sentence, response sentence) pair the aim is to go from probabilities at the model sentence level to the concept level: Let pᵢ be the probability that an answer entails (or match) a concepts, we consider

pᵢ=max_{j,r} {p(ModelSentenceᵢⱼ, AnswerSentenceᵢᵣ)}

where j is the number of model sentences under conceptᵢ and r is the number of answer sentences.

Assume now that for a certain answer, the above formula is used to compute pᵢ for each i. How would the (real number) score be computed? Currently, we consider the real number score to be the expected value of the score. For example, consider an item with 4 concepts and assume we have already calculated the pᵢ. Consider Table 3. The concept match is a list of matched concepts. Score is the score given under binary scoring with integer scores for exactly those concepts matched (calculated using the scoring rules of the item at hand) and Probability is the probability the student had exactly those concepts' matches. In this case, real number score=

0* (1−p1)(1−p2)(1−p3)(1−p4)+1*p1(1−p2)(1−p3)(1−p4)+1*(1−p1)p2(1−p3)(1−p4)+ . . . +1*p1p2p3p4

Now, how to incorporate RNS with concept-based scoring and threshold changes at the concept level? To this end we use a linear adjustment:

$${\hat{p}}_{i} = \{ \begin{matrix}\frac{0.5}{{t}_{i}} {p}_{i} \text{:} {p}_{i} \leq {t}_{i} \\ \frac{0.5}{1 - {t}_{i}} {p}_{i} + \frac{0.5 - {t}_{i}}{1 - {t}_{i}} \text{:} {p}_{i} \leq {t}_{i}\end{matrix}$$

where tᵢ is the threshold for concept i. We can use \hat{p}ᵢ wherever pᵢ appears in the RNS formula.

Two subtasks that we have not considered a solution to yet are: How to validate a RNS? and How to interpret or justify a score?

Having the above, we can make an empirical comparison of various scoring methods.

### Overall Results: Thresholds and Real Number Scoring

The comparison is between concept-based scoring with default (0.5) and optimized (Opt) thresholds either with real number (R) or integer (I) scoring. Here, we report results only for blind data for items 3 and 4, respectively. Table 4 and 5 show the results of the comparison. Note that the rows in the tables correspond to % agreement, Pearson's correlation, Unweighted kappa, Linear weighted kappa, Quadratic weighted kappa, respectively. Note also that the comparison between a rule-based Goldmap and a probabilistic Goldmap is complex on these items from a psychometric point of view since the engine and the model building software has changed dramatically. However, we are planning to conduct a comparison from a linguistic point of view.

For the Biology item, Pearson's correlation between I0.5 to R-0.5 is 0.998 and Pearson's I-opt to R-opt is 0.995. For the English item, Pearson's correlation between I-0.5 to R-0.5 is 0.984 and Pearson's between I-Opt and R-Opt is 0.982. We have evaluated the Pearson correlation between I-0.5 and R-0.5 on 241 items and there is no significant difference.

c-rater for Learning

In the past, c-rater's feedback consisted merely of a message indicating right or wrong. We have changed the way c-rater scores students' answers in order to increase the accuracy in tracking down the main ideas that students get wrong or right. This allows us to give more informative feedback for each answer c-rater scores without having to go into a full dialog-based system yet not restrict ourselves just to pre-canned hints and prompts. We can find specific evidence of what a student knows or can do. Consequently, we are able to involve a student and give her/him direct customized or individual feedback, especially when individual human help is not available.

Currently, enhanced by concept-based scoring, c-rater gives quality feedback indicating to the students which concepts in their answers they get right and which concept they get wrong with the capability of scaffolding additional questions and hints. When students get a concept or an answer wrong c-rater has different modes to choose from (to give feedback) depending on the application at hand, the grade level and the difficulty of the item. The following cases occur:

A concept that is partially wrong. There are several key elements and the student gets all except one of them correct and that one she got it partially right.

Scenario 1: Assume one student enters 5 out of 6 correct elements in item 1 and for the 6th element she enters a partially-right answer. c-rater prompts her/him with the correct parts and acknowledges the partially correct part while correcting the part that is not correct.

Scenario 2: Assume a student gives an answer like increased digestion for decreased digestion. In that case, c-rater tells the student that increased digestion does the opposite of what the body needs to do and asks the student to try again. Instead of giving the right answer the idea is to give a hint that is most specific and suitable for the answer that the student provided, e.g., if for the same item, the student writes the digestive process changes then c-rater's prompt would be either give a qualification for that change or simply changes how?.

A particular concept is completely wrong. There are two feedback modes for c-rater.

1. c-rater provides the correct concept(s) or

2. c-rater gives hints to the student that are specific and most suitable for the answer and ask him/her to try again (see 2(a) below)

All that the student enters is wrong. Again, there are two feedback modes in c-rater.

1. c-rater simply lists the right concepts or key elements

2. c-rater asks scaffolded questions to the student to check whether the student understands the question or not (if a student does not understand the question then obviously they cannot reply), e.g., c-rater prompts the student: do you know the definition of homeostasis? c-rater expects a yes or no answer.

(a) if YES then c-rater asks the student to provide the definition. c-rater then scores the answer that the student provides (treats it as another item short item to score/layers of scaffolding can be introduced). If c-rater decides the answer is wrong then it provides the definition and asks the student to try the question again. If c-rater decides the student knows the definition then it starts giving the student some hints to help him/her. The hints could be remedial or instructional depending on the application, the grade level and the difficulty of the item.

(b) if NO then c-rater provides the definition and gives the student another chance to answer [repeat process (a)].

This whole process is strengthened by a self-assessment feature. This is a confidence measure that c-rater provides with each score as we mentioned above. If in doubt, c-rater will flag the particular case for a human to score and/or give feedback. We also give feedback to students on their spelling mistakes and help them figure out the right spelling. The plan for the future is to do the same for grammatical errors.

We have also integrated m-rater, which is ETS's Maths scoring engine, into c-rater. Hence, we are in the process of adding enhancements to deal with items whose answers are a hybrid of text, graphs, and Mathematical symbols and being able to give students feedback on some common misconceptions they fall into while solving a Maths problem. We intend to enhance c-rater to give more directed and customized feedback by collaborating with teachers to be better informed on the practical needs of their students and their various capabilities. The plan is to be able to give a report on students' space of knowledge based on concepts they got right or wrong, number of hints and scaffolded prompts they needed, feedback, and the time a student took to answer.

### Semantics and Inferences

We said above that we consider the problem to be a TE problem, and this requires extracting more semantics than we actually do and the use of world knowledge. Up to now, we have depended on lexical semantics (mainly synonyms of lexicon) and simple semantic roles. Even with lexical semantics, we need to include many more enhancements.

Sentences like the British prevented them from owning lands will not match to not owning land unless the implicit negation in the word prevent will be stated clearly. In addition to semantics and world knowledge, what distinguishes the task of automatic content scoring from other textual entailment tasks is that the context of the item needs to be considered.

Further, one main limitation in Goldmap is that it deals with sentence pairs and not (answer, concept) pairs. This way it not only favors badly written long sentences over short discrete sentences but it will miss the entailment if it is over more than one sentence.

### Automatic Content Scoring: Others' Work

In the last few years, a keen interest in automatic content scoring of constructed response items has emerged. Several systems for content scoring exist. We name a few, namely, TCT (Larkey 1998), SEAR (Christie 1999), Intelligent Essay Assessor (Foltz, Laham, & Landauer 2003), IEMS (Ming, Mikhailov, & Kuan 2000), Automark (Mitchell et al 2002), C-rater (Leacock & Chodorow 2003), OXFORD-UCLES (Sukkarieh, Pulman, & Raikes 2003), Cannel (Rosé et al. 2003), JESS (Ishioka & Kameda 2004), etc. The techniques used vary from latent semantic analysis (LSA) or any variant of it, to data mining, text clustering, information extraction (IE), BLEU algorithm or a hybrid of any of the above. The languages dealt with in such systems are English, Spanish, Japanese, German, Finnish, Hebrew, or French. However, the only four systems that deal with both short answers and analytic-based content are Automark at Intelligent Assessment Technologies, c-rater at Educational Testing Service(ETS), the Oxford-UCLES system at the University of Oxford and CarmelTC at Carnegie Mellon University. The four systems deal only with answers written in English. Though Automark, c-rater and OXFORD-UCLES were developed independently, their first versions worked very similarly using a sort of knowledge-engineered E approach taking advantage of shallow linguistic features that ensure robustness against noisy data (students' answers are full of misspellings and grammatical errors). Later on, OXFORD-UCLES experimented with data mining techniques similar to the ones in CarmelTC. Though these latter techniques proved very promising in categorizing students' answers into classes (corresponding to the main points expected in an answer—or none of the concepts), the models of most of these techniques are not transparent, an issue that researchers who use data mining techniques for educational purposes need to address.

There is no evaluation benchmark to compare results with Automark, Carmel and OXFORD-UCLES. We would like to develop a benchmark set since we believe that this will contribute to and help automatic content scoring research but IP issues on items and their answers currently prevent us from doing so.

We have described c-rater, ETS's technology for automatic content scoring of short constructed responses. We have also reported on a study and two experiments that we conducted in the hope to improve the accuracy of its crater's scores and feedback. The results were promising, but more work needs to be done. In the near future, we will be concentrating on improving and adding tools that will help us obtain additional linguistic features in order to perform a more informed TE task. In particular, an evaluation of full-parsing, partial-parsing, and phrase chunking which is more in tandem with full-parsing (for example where PP attachment are not lost in the chunks) is being investigated on c-rater's data. More than one parsing mechanism is to be included, one as a fallback strategy to the other (when deeper-parsing results are deemed unreliable) and potentially a semantic representation will be added to the output of the parser.

c-rater's concept-based scoring allows it to give more powerfully individualized feedback on concepts expected in the knowledge space of a student. Since c-rater automatically scores the content of short free-text, introducing scaffolded prompts and scoring these prompts are in c-rater's nature; thus assessment and learning go in tandem in a literal sense. c-rater can also give feedback on spelling, vocabulary, and syntactic ambiguity, and eventually could give reports for students, teachers, or parents. Each feedback type will be individualized depending on the content of a student's answer.

In general, computer programs implementing the method of this invention may be distributed to users on a distribution medium such as floppy disk or CD-ROM, or over a network or the Internet. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention.

The above methods may exist in a variety of forms both active and inactive. For example, they may exist as a software program or software programs comprised of program instructions in source code, object code, executable code or other formats. Any of the above may be embodied on a computer readable medium, which includes storage devices, and signals in compressed or uncompressed form. Examples of computer readable storage devices include conventional computer system RAM (random access memory), ROM (read only memory), EPROM (erasable programmable ROM), EEPROM (electrically erasable programmable ROM), flash memory, magnetic or optical disks or tapes, or any other medium that can be used to store data. Examples of computer readable signals, whether modulated using a carrier or not, include signals that a computer system hosting or running the computer program may be configured to access, including signals downloaded through the Internet or other networks. Concrete examples of the foregoing include distribution of the program or programs on a CD ROM or via Internet download. The term “computer-readable medium” encompasses distribution media, intermediate storage media, execution memory of a computer, and any other medium or device capable of storing for later reading by a computer, or computer system a computer program implementing the method of this invention.

Additionally, some or all of the users of the above methods may exist as a software program or software programs. For example, some or all of the users referred to herein may include software agents configured to analyze and score responses. In this regard, the software agent or agents may exist in a variety of active and inactive forms.

Other digital computer system configurations can also be employed to perform the method of this invention, and to the extent that a particular system configuration is capable of performing the method of this invention, it is equivalent to the representative digital computer system described above, and within the scope and spirit of this invention. Once programmed to perform particular functions pursuant to instructions from program software that implements the method of this invention, such digital computer systems in effect become special-purpose computers particular to the method of this invention.

While the invention has been described in terms of several preferred embodiments, there are alterations, permutations, and equivalents that fall within the scope of this invention. It should also be noted that there are alternative ways of implementing both the process and apparatus of the present invention. For example, steps do not necessarily need to occur in the orders shown in the accompanying figures, and may be rearranged where appropriate. It is therefore intended that the appended claim includes all such alterations, permutations, and equivalents as fall within the true spirit and scope of the present invention.

### REFERENCES

Abney, S. 1991. Principle-Based Parsing. Kluwer Academic Publishers. chapter Parsing by Chunks.

Brent E., Carnahan T., Graham C. and McCully, J.: Bringing Writing Back Into the Large Lecture Class with SAGrader. Paper presented at the annual meeting of the American Sociological Association, Montreal Convention Center, Montreal, Quebec, Canada, Aug. 11, 2006.

Callear D., Jerrams-Smith J. and Soh V.: CAA of Short Non-MCQ answers. In Proceedings of the 5^{th} international Computer Assessment conference (2001).

Christie, J. 1999. Automated essay marking for both content and style. In Proceedings of the 3rd International Computer Assisted Assessment Conference.

Foltz, P.; Laham, D.; and Landauer, T. 2003. Automated essay scoring. In Applications to educational technology.

Ishioka, T., and Kameda, M. 2004. Automated japanese essay scoring system: Jess. In In Proceedings of the 15th International Workshop on database and Expert Systems applications.

Laham D. and Foltz, P. W.: The intelligent essay assessor. In TK Landauer (Ed.), IEEE Intelligent Systems (2000).

Larkey, L. 1998. Automatic essay grading using text categorization techniques. In In proceedings of the 21st annual international ACM SIGIR Conference on Research and Development in Information Retrieval.

Leacock, C., and Chodorow, M. 2003. C-rater: Automated scoring of short-answer questions. Computers and Humanities 37:4.

Mason O. and Grove-Stephenson I.: Automated free-text marking with paperless school. In Proceedings of the 6^{th} International Computer Assisted Assessment Conference (2002).

Ming, Y.; Mikhailov, A.; and Kuan, T. L. 2000. Intelligent essay marking system. Technical report Learner Together NgeANN Polytechnic, Singapore.

Mitchell, T.; Russel, T.; Broomhead, P.; and Aldrige, N. 2002. Towards robust computerised marking of free-text responses. In In Proceedings of the 6th International Computer Assisted Assessment Conference.

Peréz Marin D. R.: Automatic evaluation of users' short essays by using statistical and shallow natural language processing techniques. Diploma Thesis. (2004).

Rehder B., Schreiner M. E., Wolfe M. B. W., Laham D., Landauer T. K., Kintsch W.: Using Latent Semantic Analysis to assess knowledge: Some technical considerations (1998).

Rosé, C. P.; Roque, A.; Bhembe, D.; and VanLehn, K. 2003. A hybrid text classification approach for analysis of student essays. In Building Educational Applications Using NLP.

Rudner L. and Liant T.: Automated Essay Scoring Using Bayes' Theorem. In Proceedings of the annual meeting of the National Council on Measurement in Education (2002).

Shute V. J.: Focus on Formative Feedback. Educational Testing Service report series. (2007).

Srihari S. N., Srihari R. K., Srinivasan H. and Babu P.: On the Automatic Scoring of Handwritten Essays, in Proc. International Joint Conference on Artificial Intelligence (IJCAI), Hyderabad, India, pp. 2880-2884 (2007).

Sukkarieh, J. Z., and Pulman, S. G. 2005. Information extraction and machine learning: Auto-marking short free text responses to science questions. In Proceedings of the 12th International Conference on AI in Education.

Sukkarieh, J. Z.; Pulman, S. G.; and Raikes, N. 2003. Auto-marking: using computational linguistics to score short, free text responses. In Presented at the 29th IAEA.

Vantage. A study of expert scoring an IntelliMetric scoring accuracy for dimensional scoring of grade 11 student writing responses. Technical report RB-397, Vantage Leaning Tech (2000).

TABLE 1
Sample items in Biology and Reading Comprehension

| Statement of the Item | Rubric |
|---|---|
| Item 1. Full credit is 2 | Concepts: 6 |
| Identify TWO common | C1: cellular respiration; C2: increased |
| ways the body | breathing rate; |
| maintains homeostatis | C3: decreased digestion; C4: sweating; |
| during exercise | C5: dilation of blood vessels; C6 increased |
| | circulation rate |
| Scoring Guide | 2 points for 2 or more elements |
| | 1 point for 1 element else 0 |
| Item 2. Full credit is 1 | Concepts: 3 |
| According to the text (a text has been given), | C1: They both used bulky hides; |
| what was one SIMILARITY between robes | C2: They were both flatly painted; |
| with abstract designs and robes with life | C3: They were both painted by Plains Indians; |
| scenes? | |
| Scoring Guide | 1 point for each element |
| Item 3. Full credit is 3 | Concepts: 24 |
| Identify three ways in which an | C1: temperature change or fever; |
| animal's body can respond to an | C2: water loss; |
| invading pathogen. | C3: production of more mucus; |
| | 21 other concepts that we will not list here |
| Scoring Guide | 1 point for each element |
| Item 4. Full credit is 2 | Concepts: 11 |
| (a reading is given) Explain | C1: to understand the conflict with England; |
| what you think the delegates | C2: to take their side against England; |
| may be trying to persuade | C3: to appeal to the Native Americans; |
| the Native Americans to believe | C4: by calling them as brothers; |
| or to do. Then, name an example of how | C5: use authoritative language; |
| the delegates attempt to persuade | 6 other concepts |
| through their speech. | |
| Scoring Guide | 1 point for ‘what’ concept |
| | 1 point for ‘how’ concept |

TABLE 2
Concept Scoring for the Biology and English items for blind data

| | Bio | | | English | | |
|---|---|---|---|---|---|---|
| | H1-H2 | C-H1 | C-H2 | H1-H2 | C-H1 | C-H2 |
| C1 | 0.96 | 0.93 | 0.93 | 0.17 | 0.1 | 0.19 |
| C2 | −0.001 | 0.67 | 0.67 | 0.83 | 0.73 | 0.7 |
| C3 | 1 | 1 | 1 | 0.83 | 0.73 | 0.7 |
| C4 | 1 | 0 | 0 | −0.003 | 0.23 | −0.005 |
| C5 | 1 | 1 | 1 | 0.08 | 0.15 | 0.14 |
| C6 | 1 | 0 | 0 | 0.42 | 0.33 | 0.24 |
| C7 | 1 | 1 | 1 | 0.33 | 0.26 | 0.2 |
| C8 | −0.001 | −0.001 | −0.005 | 0.06 | 0 | 0 |
| C9 | 0.94 | 0.94 | 1 | 0.38 | 0.35 | 0.3 |
| C10 | 0.76 | 0.94 | 0.8 | 0.33 | 0.42 | 0.45 |
| C11 | 0.67 | 1 | 0.67 | 0.09 | 0 | 0 |
| C12 | 0.98 | 0.95 | 0.97 | | | |
| C13 | 0.5 | 0.5 | 0.67 | | | |
| C14 | 0 | 0 | 0.67 | | | |
| C15 | 0.36 | 0.67 | 0.6 | | | |
| C16 | 0.93 | 0.93 | 0.87 | | | |
| C17 | 0.7 | 0.48 | 0.51 | | | |
| C18 | 0.85 | 0.69 | 0.87 | | | |
| C19 | 0.9 | 0.92 | 0.89 | | | |
| C20 | 0.85 | 0.8 | 0.76 | | | |
| C21 | 0.63 | 0.66 | 0.58 | | | |
| C22 | 0.92 | 0.92 | 0.93 | | | |
| C23 | 0.75 | 0.79 | 0.69 | | | |
| C24 | 0.93 | 0.85 | 0.81 | | | |
| Overall | 0.76 | 0.74 | 0.67 | 0.69 | 0.55 | 0.53 |

TABLE 3
Example on expected value calculation

| Concept Match | Score | Probability |
|---|---|---|
| None | 0 | (1 − p₁)(1 − p₂)(1 − p₃)(1 − p₄) |
| 1 only | 1 | p₁(1 − p₂)(1 − p₃)(1 − p₄) |
| 2 only | 1 | (1 − p₁) p₂ (1 − p₃(1 − p₄) |
| 3 only | 1 | (1 − p₁)(1 − p₂) p₃ (1 − p₄) |
| 4 only | 0 | (1 − p₁)(1 − p₂)(1 − p₃) p₄ |
| 1, 2 | 2 | p₁ p₂ (1 − p₃)(1 − p₄) |
| 1, 3 | 2 | p₁ (1 − p₂) p₃ (1 − p₄) |
| 1, 4 | 1 | p₁ (1 − p₂)(1 − p₃) p₄ |
| 2, 3 | 2 | (1 − p₁) p₂ p₃ (1 − p₄) |
| 2, 4 | 1 | (1 − p₁) p₂ (1 − p₃) p₄ |
| 3, 4 | 1 | (1 − p₁)(1 − p₂) p₃ p₄ |
| 1, 2, 3 | 2 | p₁ p₂ p₃ (1 − p₄) |
| 1, 2, 4 | 1 | p₁ p₂(1 − p₃) p₄ |
| 1, 3, 4 | 1 | p₁(1 − p₂) p₃ p₄ |
| 2, 3, 4 | 1 | (1 − p₁) p₂ p₃ p₄ |
| 1, 2, 3, 4 | 1 | p₁ p₂ p₃ p₄ |

TABLE 4
Empirical Comparison for scores: Biology item

| | C-H1 | | | | C-H2 | | | |
|---|---|---|---|---|---|---|---|---|
| H1-H2 | I-0.5 | R-0.5 | I-Opt | R-Opt | I-0.5 | R-0.5 | I-Opt | R-Opt |
| 83 | 81.8 | | 81.4 | | 76.4 | | 76.4 | |
| 0.91 | 0.89 | 0.89 | 0.89 | 0.89 | 0.86 | 0.86 | 0.86 | 0.86 |
| 0.76 | 0.74 | | 0.74 | | 0.67 | | 0.67 | |
| 0.84 | 0.81 | | 0.81 | | 0.77 | | 0.77 | |
| 0.91 | 0.89 | | 0.89 | | 0.89 | | 0.86 | |

TABLE 5
Empirical Comparison for scores: English item

| | C-H1 | | | | C-H2 | | | |
|---|---|---|---|---|---|---|---|---|
| H1-H2 | I-0.5 | R-0.5 | I-Opt | R-Opt | I-0.5 | R-0.5 | I-Opt | R-Opt |
| 80.7 | 72.2 | | 72.1 | | 70.7 | | 70.6 | |
| 0.8 | 0.65 | 0.66 | 0.64 | 0.66 | 0.63 | 0.65 | 0.62 | 0.65 |
| 0.69 | 0.55 | | 0.55 | | 0.53 | | 0.53 | |
| 0.76 | 0.6 | | 0.6 | | 0.58 | | 0.58 | |
| 0.8 | 0.64 | | 0.64 | | 0.63 | | 0.62 | |

We claim:

1. A method of generating a real number score for a response comprising:
providing a scoring model having one or more concepts;
determining for each concept a probability that the concept is present in the response;
determining a scoring rule function;
determining an expected value function for the scoring rule function; and
generating a real number score for the response based on the scoring rule function, the expected value function, and the probabilities that the concepts are present in the response.

2. The method of claim 1 further comprising determining a scoring rubric, and wherein the scoring model is based on the scoring rubric.

3. The method of claim 1 further comprising:
identifying one or more model sentences corresponding to each concept; and
determining for each of the model sentences a probability that the model sentence is present in the response.

4. The method of claim 3 wherein the probability that a concept is present in the response is based on the probability that each of the model sentences corresponding to the concept is present in the response.

5. The method of claim 4 wherein the probability that a concept is present is calculated as the maximum probability that any one of each of the model sentences corresponding to the concept is present in the response.

6. The method of claim 4 further comprising the step of determining for each concept a correlation between the probabilities that each of the model sentences corresponding to the concept is present in the response, and wherein the correlation is used to calculate the probability that the concept is present.

7. The method of claim 1 further comprising determining a scoring rubric, and wherein the scoring rule function is based on a scoring rubric.

8. The method of claim 1 further comprising the step of determining the canonical formula for the scoring rule.

9. The method of claim 1 wherein determining the expected value function for the scoring rule function is based on the following equation:
$$g ( p ) = {\sum }_{u} f ( u ) P ( u ) = {\sum }_{u} ( f ( u ) {\prod }_{i = 1}^{n} ( {p}_{i}^{{u}_{i}} {q}_{i}^{1 - {u}_{i}} ) ) ;$$
wherein u is a response vector for the scoring model, p is a probability vector, g is the expected value function, f is the scoring rule as expressed as a function, pᵢ is the probability that a concept Cᵢ is present, and qᵢ is the probability that a concept Cᵢ is not present.

10. A method of determining a probability that a concept is present in a response comprising:
determining one or model sentences for the concept;
determining for each model sentence the probability that the model sentence or an acceptable form thereof is present in the response; and
generating a probability that the concept is present based on the combined probabilities that the model sentences are present in the response.

11. The method of claim 10 wherein generating the probability that the concept is present comprises determining the maximum probability that any one the concept model sentences is present in the response.

12. The method of claim 10 wherein generating the probability that the concept is present comprises determining correlations between model sentences.

13. The method of claim 10 wherein determining correlations between model sentences comprises determining conditional probabilities for each model sentence being present with respect to other model sentences.

14. A method of generating a real number scoring method system comprising:
creating a scoring model having one or more concepts;
determining for each concept a probability that the concept is present in the response;
generating a scoring rule function; and
generating an expected value function for the scoring rule function.

15. The method of claim 14 further comprising validating the real number scoring method.

16. The method of claim 15 where validating the real number scoring method comprises:
providing a multiplicity of responses;
generating real number scores for each of the multiplicity of responses using the expected value function;
calculating integer scores for the multiplicity of responses using a controlled scoring method; and
comparing the real number scores to the integer scores to generate a validity quotient.

17. A method of validating a real number scoring method comprising:
providing a multiplicity of responses;
creating a scoring model having one or more concepts;
determining for each response a probability that each concept is present in the response;
creating a scoring rule function;
determining an expected value function for the scoring rule function;
generating real number scores for each of the multiplicity of responses using the expected value function;
calculating integer scores for the multiplicity of responses using a controlled scoring method; and
comparing the real number scores to the integer scores to generate a validity quotient.

18. The method of claim 17 wherein the validity quotient is the generalized quadratic kappa value.

19. The method of claim 17 wherein comparing the real number scores to the integer scores comprises rounding the real number scores to the nearest integer, and wherein the validity quotient is the quadratic-weighted kappa.
